(19) United States
(12) Patent Application Publication
(10) Pub. No.: US 2018/0229692 A1
(43) Pub. Date: Aug. 16, 2018

(54) SYSTEM AND METHOD OF OPERATING WINDSHIELD WIPERS OF A SEMI-AUTONOMOUS MOTOR VEHICLE

(71) Applicant: FORD GLOBAL TECHNOLOGIES, LLC, Dearborn, MI (US)

(72) Inventors: Yonghua Li, Ann Arbor, MI (US); Qiong Lan, Ann Arbor, MI (US)

(21) Appl. No.: 15/430,684

(22) Filed: Feb. 13, 2017

(51) Int. Cl. B60S 1/08

(52) U.S. Cl. CPC B60S 1/0896; B60S 1/0818

(57) ABSTRACT

A windshield wiper operating system is provided for a semi-autonomous motor vehicle. That windshield wiper operating system includes a windshield wiper, a windshield wiper drive motor and a controller configured to deactivate the windshield wiper operation when raining and the semi-autonomous motor vehicle is in autonomous driving mode. A related method is also disclosed.

### TECHNICAL FIELD

This document relates generally to the motor vehicle equipment field and, more particularly, to a system and method for operating windshield wipers of a semi-autonomous motor vehicle.

### BACKGROUND

Semi-autonomous motor vehicles are able to detect surroundings using a variety of technologies, such as radar, LIDAR, GPS and computer vision, and utilize advanced control systems to analyze and interpret sensory data and thereby identify an appropriate navigation path. This document relates to a windshield wiper operating system and related method for semi-autonomous motor vehicles and, more particularly, SAE level 3-4 semi-autonomous motor vehicles.

More specifically, SAE level 3 semi-autonomous motor vehicles allow a driver to safely turn their attention away from driving tasks within known, limited environments, such as freeways. SAE level 4 autonomous motor vehicles do not require driver attention when the control system of the autonomous motor vehicle is operating in all but a few environments. As should be appreciated, SAE level 3 and level 4 semi-autonomous motor vehicles allow for autonomous and human driving alternations. As such, all important manual driving related controls, such as pedals, power steering, mirror, windshield wiper and the like will have the capability of being controlled by a human driver.

This document relates to a new and improved windshield wiper operating system for semi-autonomous motor vehicles that is capable of monitoring ambient conditions and save battery energy of a semi-autonomous motor vehicle by deactivating operation of the windshield wiper drive motor in rainy conditions when operating in the autonomous driving mode.

### SUMMARY

In accordance with the benefits and advantages described herein, a windshield wiper operating system is provided for a semi-autonomous motor vehicle. That windshield wiper operating system comprises a windshield wiper, a windshield wiper drive motor and a controller. The controller is configured to deactivate the windshield wiper operation when raining and the semi-autonomous motor vehicle is in autonomous driving mode.

The controller may be configured to have a first data input for driving mode data. The controller may also be configured to have a second data input for current precipitation data. Further, the controller may be configured to have a third data input for current ambient temperature data.

In accordance with an additional aspect, a method is provided for operating a windshield wiper system of a semi-autonomous motor vehicle. That method comprises the step of deactivating, by controller, operation of a wiper drive motor when raining and the semi-autonomous motor vehicle is in autonomous driving mode. Further, the method may include the step of saving battery energy by deactivating operation of the wiper drive motor when raining and in the autonomous driving mode.

The method may also include the step of monitoring, by drive mode monitoring device, a current driving mode of the semi-autonomous motor vehicle. Further, the method may include the step of monitoring, by precipitation monitoring device, current precipitation. In addition, the method may include the step of monitoring, by ambient temperature monitoring device, current ambient temperature.

The method may also include the step of activating, by the controller, operation of the wiper drive motor when raining and the semi-autonomous motor vehicle is switched to manual or driver driving mode from the autonomous driving mode. Still further, the method may include the step of setting, by the controller, a calibrated speed for operation of the wiper drive motor based upon rate of rainfall when activating operation of the wiper drive motor.

Still further, the method may include the step of activating, by the controller, operation of the wiper drive motor when snowing and the semi-autonomous motor vehicle is either in autonomous driving mode or driver driving mode. Still further, the method may include the step of deactivating, by the controller, operation of the wiper drive motor when no current precipitation is detected.

In the following description, there are shown and described several preferred embodiments of the windshield wiper operating system and related operating method. As it should be realized, the windshield wiper operating system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the windshield wiper operating system and related method and together with the description serve to explain certain principles thereof. In the drawing figures:

FIG. 1 is a schematic block diagram of the windshield wiper operating system for a semi-autonomous motor vehicle.

FIG. 2 is a schematic block diagram of the controller of the windshield wiper operating system illustrated in FIG. 1.

FIG. 3 is a schematic block diagram of an alternative embodiment of a controller for the windshield wiper operating system illustrated in FIG. 1.

Reference will now be made in detail to the present preferred embodiments of the windshield wiper operating system, examples of which are illustrated in the accompanying drawing figures.

### DETAILED DESCRIPTION

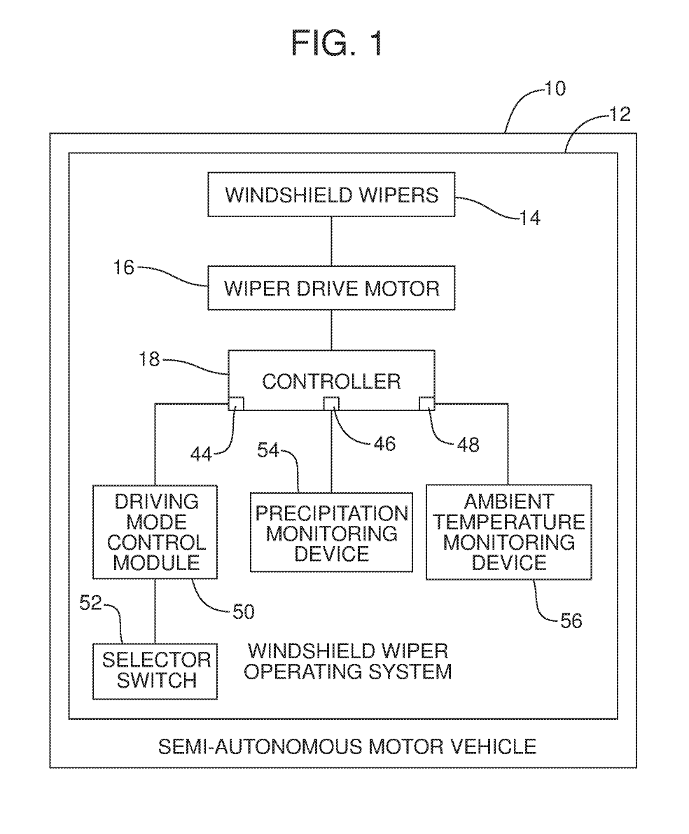

Reference is now made to FIG. 1 which schematically illustrates a semi-autonomous motor vehicle 10 equipped with the windshield wiper operating system 12. The windshield wiper operating system 12 includes one or more windshield wipers 14 driven by one or more wiper drive motors 16 in a manner known to those skilled in the art of motor vehicle construction.

The windshield wiper operating system 12 also includes a controller 18 that is configured to deactivate windshield wiper operation when current ambient conditions include rain and the semi-autonomous motor vehicle 10 is in autonomous driving mode.

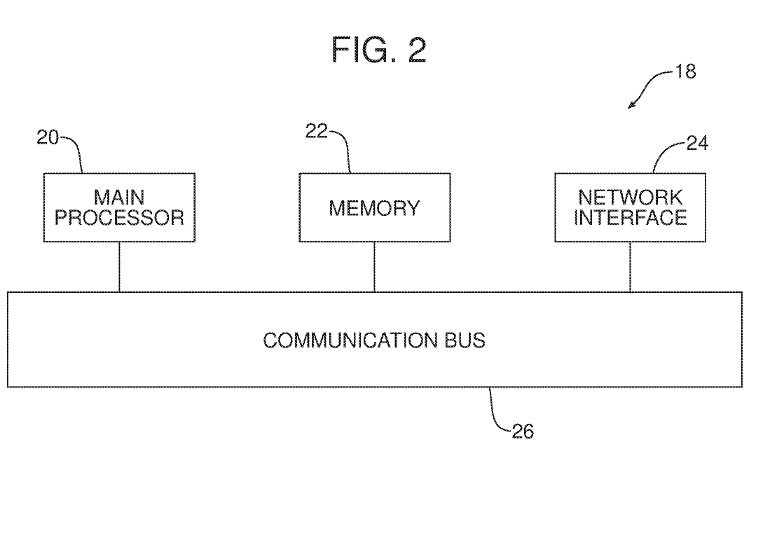

Controller 18 may comprise a computing device such as a dedicated microprocessor or an electronic control unit (ECU) operating in accordance with instructions from appropriate control software. Thus, as illustrated in FIG. 2, the controller 18 may comprise one or more processors 20, one or more memories 22 and one or more network interfaces 24 all in communication with each other over a communication bus 26.

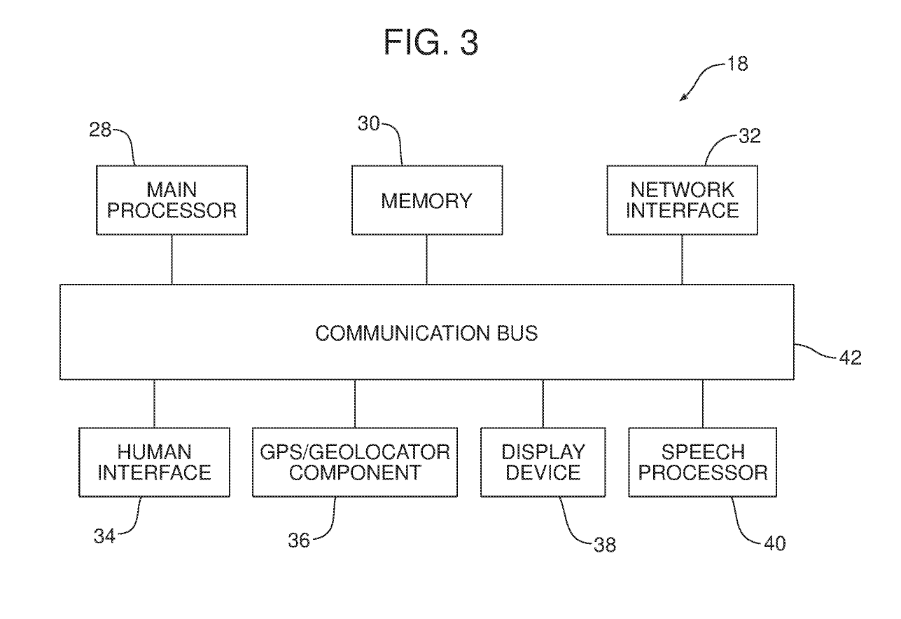

In yet another possible embodiment illustrated in FIG. 3, the controller 18 may comprise a body control module or BCM including one or more processors 28, one or more memories 30, one or more network interfaces 32, a human interface 34, a GPS/geolocator component 36, a display device such as a multi-function display with touchscreen capability 38 and a speech processor 40 that all communicate with each other over a communication bus 42. Such a BCM controller 18 may perform a number of interior body electrically-based functions including, for example, interior locking, remote key entry, interior lighting, exterior lighting, windshield wiper control and the like. In some embodiments the BCM controller 18 may also function to control entertainment functions (e.g. radio, CD player) and communications such as telephone and internet communications over a wireless network. Still further, in some embodiments the BCM controller 18 may be connected by a communication bus (not shown) to other control modules that provide one or more of these additional functions.

Referring back to FIG. 1, the controller 18 may be configured to include a plurality of data inputs including, for example, a first data input 44, a second data input 46 and the third data input 48. In the illustrated embodiment, the first data input 44 is connected to a driving mode control module 50 and receives driving mode data indicating whether the semi-autonomous motor vehicle is in (a) an autonomous or self-driving mode or (b) a manual or driver controlled mode. The motor vehicle operator may select between the autonomous driving mode and the driver mode by means of the selector switch 52 connected to the driving mode control module 50.

The second data input 46 is connected to a precipitation monitoring device 54 such as a rain sensor, a precipitation detection camera, a window fogging detection camera or other appropriate means. As should be appreciated, the precipitation monitoring device provides the second data input 46 with current precipitation data.

As further illustrated in FIG. 1, the third data input 48 is connected to an ambient temperature monitoring device 56 of a type known in the art. Such an ambient temperature monitoring device 56 provides current ambient temperature data to the controller 18 at the third data input 48.

While not explicitly illustrated, it should be appreciated that the controller 18 may be connected to a controller area network (CAN) to receive data from a number of other different control modules, monitoring devices or sensors of the semi-autonomous motor vehicle 10 including, but not necessarily limited to, a passenger compartment humidity sensor, an ambient humidity sensor, an air circulation system duct humidity sensor, an air circulation system evaporator thermistor, a sun load sensor, a passenger compartment temperature sensor, and the like.

Consistent with the above description, a method is provided of operating a windshield wiper system 12 of a semi-autonomous motor vehicle 10. That method may be broadly described as comprising the step of deactivating, by the controller 18, operation of the wiper drive motor 16 when the semi-autonomous motor vehicle is being operated in raining conditions as detected by the precipitation monitoring device 54 and the semi-autonomous motor vehicle is in autonomous driving mode as detected by the driving mode control module 50.

Still further, the method may include the step of saving battery energy by deactivating operation of the wiper drive motor 16 when data received at the second data input 46 from the precipitation monitoring device 54 indicates current rain and data received at the first data input 44 from the driving mode control module 50 indicates that the motor vehicle is in autonomous driving mode.

Thus, it should be appreciated that the method may also include monitoring, by the driving mode monitoring device 50, the current driving mode of the semi-autonomous motor vehicle 10 as selected by the motor vehicle operator through the selector switch 52. Further, the method may also include the step of monitoring, by the precipitation monitoring device 54, current precipitation. In addition, the method may include monitoring, by ambient temperature monitoring device 56 the current ambient temperature.

The method may also include the step of activating, by the controller 18, operation of the wiper drive motor 16 when the precipitation monitoring device 54 indicates current rain at the second data input 46 and the semi-autonomous motor vehicle 10 is switched to driver driving mode from the autonomous driving mode as indicated by the driving mode monitoring device 50. Still further, the method may include the step of setting, by the controller 18, a calibrated speed for operation of the wiper drive motor 16 based upon the rate of rainfall when activating operation of the wiper drive motor. More specifically, the precipitation monitoring device 54 monitors the rate of rainfall and provides data indicative of that rate of rainfall to the second data input 46. The speed of operation of the wiper drive motor 16 is then set by the controller 18 dependent upon the detected rate of rainfall: the heavier or the greater the rate of rainfall, the faster the wiper drive motor 16 is driven.

Precipitation data provided by the precipitation monitoring device 54 at the second data input 46 and ambient temperature data provided by the ambient temperature monitoring device 56 at the third data input 48 will indicate when the snow is falling. For purposes of this document, the term “snow” includes all forms of freezing winter precipitation including freezing rain and sleet as well as snow. The method includes activating, by the controller 18, operation of the wiper drive motor 16 when snowing and the semi-autonomous motor vehicle is in either the autonomous driving mode or the driver driving mode. This is done to ensure that the windows provide a clear viewing area in the event it might suddenly become necessary for the driver to take over control of the driving of the motor vehicle from the autonomous driving mode in a short period of time such as for an emergency or other reason.

Still further, the method may include the step of deactivating, by the controller 18, operation of the wiper drive motor 16 when there is no current precipitation. Thus, when the precipitation monitoring device 54 provides data at the second data input 46 indicating that the precipitation has ceased, the controller 18 will deactivate the wiper drive motor 16 and suspend operation of the windshield wipers 14.

In summary, numerous benefits are provided by the windshield wiper operating system 12 and the related method described herein. When the semi-autonomous motor vehicle 10 is being driven in rain in the autonomous driving mode, the controller 18 deactivates the wiper drive motor 16 and the windshield wipers 14 to save battery energy. This is possible since it is not necessary to maintain operation of the windshield wipers 14 for safe autonomous driving of the motor vehicle in rain. In contrast, in snow, the controller 18 provides for operation of the windshield wipers so that the windshield is maintained clear in the event it becomes necessary to suddenly switch from autonomous driving mode to driver driving mode. Of course, the windshield wiper operating system 12 may be provided with an override switch (not shown) to activate the windshield wipers 14 through the controller 18 when the operator desires to have those windshield wipers sweep the windshield clear of rain.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A windshield wiper operating system for a semi-autonomous motor vehicle, comprising:
a windshield wiper;
a windshield wiper drive motor; and
a controller configured to deactivate windshield wiper operation when raining and said semi-autonomous motor vehicle is in autonomous driving mode.

2. The windshield wiper operating system of claim 1, wherein said controller is configured to have a first data input for driving mode data.

3. The windshield wiper operating system of claim 2, wherein said controller is configured to have a second data input for current precipitation data.

4. The windshield wiper operating system of claim 3, wherein said controller is configured to have a third data input for current ambient temperature data.

5. A method of operating a windshield wiper system of a semi-autonomous motor vehicle, comprising:
deactivating, by a controller, operation of a wiper drive motor when raining and said semi-autonomous motor vehicle is in autonomous driving mode.

6. The method of claim 5, including saving battery energy by deactivating operation of said wiper drive motor when raining and in said autonomous driving mode.

7. The method of claim 6, including monitoring, by drive mode monitoring device, a current driving mode of said semi-autonomous motor vehicle.

8. The method of claim 7, including monitoring, by precipitation monitoring device, current precipitation.

9. The method of claim 8, including monitoring, by ambient temperature monitoring device, current ambient temperature.

10. The method of claim 9, including activating, by said controller, operation of said wiper drive motor when raining and said semi-autonomous motor vehicle is switched to driver driving mode from said autonomous driving mode.

11. The method of claim 10, including setting, by said controller, a calibrated speed for operation of said wiper drive motor based upon rate of rainfall when activating operation of said wiper drive motor.

12. The method of claim 11, including activating, by said controller, operation of said wiper drive motor when snowing and said semi-autonomous motor vehicle is in either autonomous driving mode or driver driving mode.

13. The method of claim 12, including deactivating, by said controller, operation of said wiper drive motor when no current precipitation is falling.

14. The method of claim 6, including monitoring, by precipitation monitoring device, current precipitation.

15. The method of claim 6, including monitoring, by ambient temperature monitoring device, current ambient temperature.

16. A method of operating a windshield wiper system of a semi-autonomous motor vehicle, comprising:
deactivating, by a controller, a wiper drive motor when raining and said semi-autonomous motor vehicle is switched to autonomous driving mode from driver driving mode.

17. The method of claim 16, including saving battery energy by deactivating operation of said wiper drive motor when raining and in said autonomous driving mode.
